(19) United States
(12) Patent Application Publication
(10) Pub. No.: US 2018/0109576 A1
(43) Pub. Date: Apr. 19, 2018

(54) REAL-TIME CONTENT PROVIDING METHOD AND SYSTEM

(71) Applicant: IT&BASIC Inc., Bucheon-si (KR)

(72) Inventors: Kyung Wook MIN, Bucheon-si (KR); Mo Hee KANG, Bucheon-si (KR); Jae Gyun LEE, Bucheon-si (KR)

(21) Appl. No.: 15/335,128

(22) Filed: Oct. 26, 2016

(30) Foreign Application Priority Data
Oct. 18, 2016 (KR) 10-2016-0135254

(51) Int. Cl. H04L 29/06; H04L 29/08

(52) U.S. Cl. CPC H04L 65/4084; H04L 67/327

(57) ABSTRACT

Provided is a real-time content providing method. The real-time content providing method includes: providing page data to a plurality of user terminals; receiving an action request from a manager terminal or from one or more user terminals; determining a type of the action request; and transmitting action response data to the manager terminal or the one or more user terminals based on the determined type of the action request, wherein the action response data is one of first action response data about a setting change of the page data and second action response data about additional data for updating the page data, and the second action response data is used to request additional response data from a server different from a server determining the type of the action request.

### CROSS-REFERENCE TO RELATED APPLICATION

This application claims the benefit of priority of Korean Patent Application No. 10-2016-0135254, filed on Oct. 18, 2016, in the Korean Intellectual Property Office, the disclosure of which is incorporated herein in its entirety by reference.

### BACKGROUND

### 1. Field

One or more embodiments relate to real-time content providing methods and systems, and more particularly, to methods and systems that, in order to prevent the traffic overload of a real-time content providing system, may classify the action requests from terminals into a first type and a second type and perform an action response to the first type action request to change the settings of page data pre-provided without additional data from servers other than a broadcasting server.

### 2. Description of the Related Art

In a synchronization network system accessed by a plurality of users, when a user changes content, the content change may be transmitted in real time to all the other users accessing the system. In the synchronization network system, since the amount of traffic increases exponentially with an increase in the number of users accessing the system, a separate technology is required to properly control the traffic.

As an example, the traffic is controlled by using a technology of limiting the number of users accessing the system, synchronizing the content not in real time but at certain time intervals, or transmitting only a limited amount of data even in the case of performing synchronization.

For example, the number of access users is limited in a chatting service, or the content is synchronized not in real time but at certain time intervals in a social network service.

### SUMMARY

One or more embodiments are related to synchronizing in real time content provided to all users accessing a content providing system and preventing traffic overload resulting therefrom.

Additional aspects will be set forth in part in the description which follows and, in part, will be apparent from the description, or may be learned by practice of the presented embodiments.

According to one or more embodiments, a real-time content providing method includes: providing page data to a plurality of user terminals; receiving an action request from a manager terminal or from one or more user terminals; determining a type of the action request; and transmitting action response data to the manager terminal or the one or more user terminals based on the determined type of the action request, wherein the action response data is one of first action response data about a setting change of the page data and second action response data about additional data for updating the page data, and the second action response data is used to request additional response data from a server different from a server determining the type of the action request.

The real-time content providing method may further include updating the page data based on an action record request according to the action request.

The first action response data and the second action response data may be transmitted by a first server to the manager terminal or to the one or more user terminals, and the second action response data may be used to request additional response data from a second server determining the type of the action request.

The first server may receive the action request from the one or more user terminals in real time and transmit the action response data to the manager terminal or the one or more user terminals in real time.

The providing of the page data may include: receiving an initial connection request from one or more user terminals; and transmitting the first page data and second page data to the one or more user terminals, wherein the second page data may be data about updating of the first page data until the time when the initial connection request is received; and the one or more user terminals receiving the first page data and the second page data may output the first page data reflecting the second page data by an output unit.

The determining of the type of the action request may include determining whether the action request is a first type action request or a second type action request, wherein the first type action request may be to request the first action response data and the second type action request may be to request the second action response data.

The first action response data may be one of hide function activation or deactivation data, survey response closing data, and survey option shading setting data.

The second action response data may be one of new page data, new survey data, survey result data, and question list data.

The real-time content providing method may further include, before the providing of the page data, a slide providing operation of converting data of a particular format into a slide format to generate the page data.

According to one or more embodiments, a real-time content providing system includes: a real-time response unit configured to receive an action request from a manager terminal or one or more user terminals, determine a type of the action request, and transmit first action response data or second action response data to the manager terminal or the one or more user terminals based on the determined type of the action request; a first data providing unit configured to receive the action request from the manager terminal or the one or more user terminals; and a second data providing unit configured to receive an action record request from the first data providing unit and updating page data, wherein the first action response data relates to the setting change of the page data, and the second action response data relates to additional data for updating the page data and is used to set the manager terminal or the one or more user terminals to request additional response data from the first data providing unit.

The first data providing unit receiving the additional response data request from the manager terminal or the one or more user terminals may be further configured to load the additional response data from the second data providing unit.

The manager terminal or the one or more user terminals receiving the first action response data may be further configured to change the settings of the page data without requesting the additional response data from the first data providing unit.

The real-time content providing system may further include a slide providing unit configured to convert data of a particular format into a slide format to generate the page data.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram illustrating a configuration of a real-time content providing system according to an embodiment;

FIG. 2 is a diagram illustrating providing of page data to a user terminal by a real-time content providing system, according to an embodiment;

FIG. 3 illustrates an example of first page data according to an embodiment;

FIGS. 4A and 4B illustrate a case where a first type action request is received, according to an embodiment;

FIG. 5 is a diagram illustrating a method of displaying content on a user terminal, according to an embodiment;

FIGS. 6A and 6B illustrate a case where a second type action request is received, according to an embodiment; and

FIGS. 7 and 8 illustrate an example of content displayed on a user terminal, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The following detailed description of the inventive concept refers to the accompanying drawings that illustrate embodiments of the inventive concept. The embodiments are described in sufficient detail to enable those of ordinary skill in the art to implement the inventive concept. It will be understood that various embodiments of the inventive concept are not necessarily mutually exclusive while being different from each other. For example, particular shapes, structures, and features described herein may be modified from some embodiments to other embodiments without departing from the spirit and scope of the inventive concept. Also, it will be understood that the position or arrangement of individual components in the respective embodiments may be modified without departing from the spirit and scope of the inventive concept. Thus, the following detailed description should be considered in a descriptive sense only and not for purposes of limitation, and the scope of the inventive concept should be construed as including the appended claims and the equivalents thereof. In the drawings, like reference numerals will denote like elements throughout various aspects.

Hereinafter, various embodiments of the inventive concept will be described in detail with reference to the accompanying drawings so that those of ordinary skill in the art may easily implement the inventive concept.

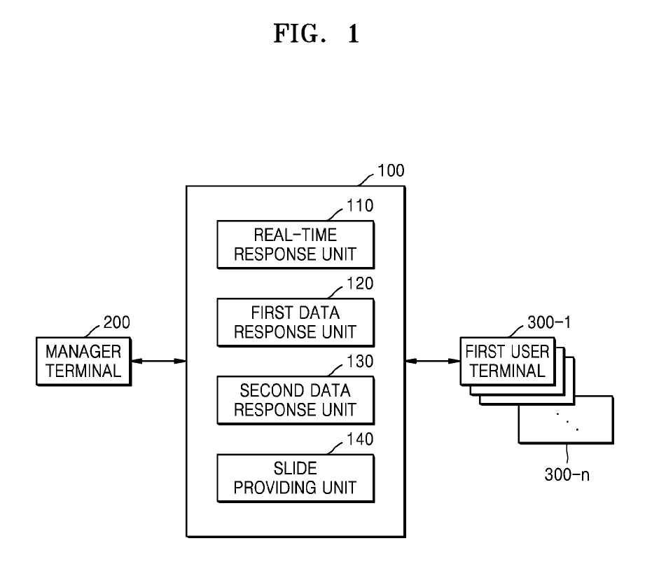

FIG. 1 is a diagram illustrating a configuration of a real-time content providing system 100 according to an embodiment.

As illustrated in FIG. 1, the real-time content providing system 100 according to an embodiment may communicate with a manager terminal 200 and a user terminal 300. The manager terminal 200 is a terminal corresponding to a manager registering initial content in the system in order to share the content with users. Also, a plurality of user terminals 300 are terminals corresponding to users sharing the content. Although the plurality of user terminals 300 are illustrated as first to nth user terminals 300-1, . . . , 300-n in FIG. 1, the first to nth user terminals 300 will hereinafter be referred to as the user terminals 300 for convenience of description.

According to an embodiment, by controlling the manager terminal 200 and the user terminals 300 in real time, the real-time content providing system 100 may control in real time the content displayed on the manager terminal 200 or the user terminals 300.

A real-time response unit 110 of the real-time content providing system 100 receives an action request from the manager terminal 200 or from one or more user terminals 300, determines a type of the action request, and transmits first action response data or second action response data to the manager terminal 200 or the one or more user terminals 300 based on the type of the action request. Also, a first data providing unit 120 receives an initial connection request from the manager terminal 200 or one or more user terminals 300 and transmits user request information to the real-time response unit 110, or receives an action request from the manager terminal 200 or one or more user terminals 300. Also, a second data providing unit 130 updates second page data according to an action record request from the first data providing unit 120, or loads response data according to a response data request from the first data providing unit 120. Also, a slide providing unit 140 converts data of a particular format into a slide format to generate the page data. The respective components of the real-time content providing system 100 will be described later in more detail with reference to the drawings.

According to an embodiment, the real-time content providing system 100 may be used to provide and control the content such as lecture data in a lecture targeted at a plurality of audiences. In more detail, the manager terminal 200 may be a terminal corresponding to a lecturer, the user terminals 300 may correspond respectively to the audiences, the real-time content providing system 100 may be a server for sharing and synchronizing the lecture content. According to an embodiment, the real-time content providing system 100 may provide the lecture content registered by the manager to the user terminals 300 in the form of a webpage and may change the settings of the webpage according to the action request from the manager or the user or provide the action response data, which is to request additional data, to the user terminals 300 in real time without traffic overload.

For example, as in the case of a lecture site, when a plurality of persons need to view the same screen by using the respective user terminals 300, a lecture content synchronization system is required. For example, if 100 persons share a webpage displaying lecture data, when one person transmits an action request for the webpage to a system, a broadcasting server of the system acquires data from a database and then applies an action response to the webpage and retransmits the changed webpage to all of the 100 persons. When all of the 100 persons take particular actions on the webpage, since the broadcasting server acquires data 100 times and then transmits the 100*100-time changed webpage to the user terminals 300, the possibility of occurrence of traffic overload increases.

In a general asynchronous webpage, since the stored webpage content may be loaded only in the case of the existence of the request of the user terminal 300, the traffic does not increase exponentially even when the number of user terminals 300 increases. However, in a synchronous webpage, regardless of the existence of the request of the user terminal 300, in the case of the existence of an action request from a particular user, data should be loaded from the database to provide the changed webpage to all the user terminals 300. Also, in the system, there is a high possibility of the occurrence of traffic overload between the database and the broadcasting server performing a real-time response action.

In order to solve this problem, in the real-time content providing system 100 according to an embodiment, the action requests from the terminals are classified into a first type and a second type, the broadcasting server performs an action response to the first type action request to change the settings of page data pre-provided without additional data from another server (or database), and the broadcasting server performs an action response only to the second type action request to order the manager or user terminals to acquire additional data from the database. Thus, as for the first type action request, the traffic overload between the server and the database does not occur in the system. Also, since the response to the first type action request changes only the settings of the pre-provided page data, the possibility of occurrence of the traffic overload between the server and the user terminal 300 decreases. According to an embodiment, the real-time content providing system 100 may provide the content registered by the manager terminal 200 to the user terminals 300 in the form of a webpage, and may provide the action response capable of changing the settings of the webpage to the user terminals 300 in real time without data overload.

For this purpose, as illustrated in FIG. 1, the real-time content providing system 100 includes the real-time response unit 110, the first data providing unit 120, the second data providing unit 130, and the slide providing unit 140. According to an embodiment, each of the real-time response unit 110, the first data providing unit 120, the second data providing unit 130, and the slide providing unit 140 may be a server or a database constituting the real-time content providing system 100. In particular, the real-time response unit 110 may be a server that responds in real time to requests from the user terminals and performs broadcasting. Also, the first data providing unit 120 and the second data providing unit 130 may be a database storing data or may be a server including a database.

Hereinafter, the inventive concept will be described by focusing on the communication of the user terminal 300 with each component in the real-time content providing system 100, according to an embodiment.

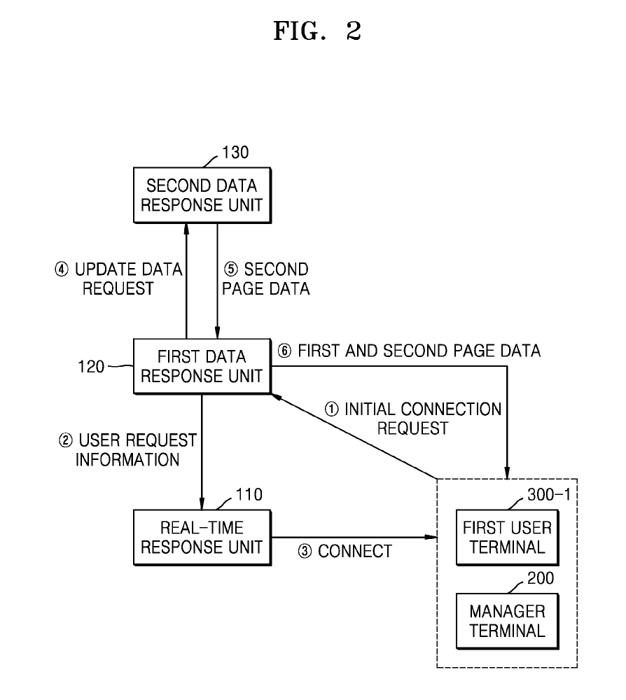

FIG. 2 is a diagram illustrating providing of the page data to the user terminal 300 by the real-time content providing system 100, according to an embodiment.

Referring to FIG. 2, according to an embodiment, one or more user terminals 300 or the manager terminal 200 transmits an initial connection request to the first data providing unit 120. In this case, the first data providing unit 120 may be a server or a database that stores and provides the first page data that is the first content registered by the manager terminal 200. According to an embodiment, the first page data may be a lecture data webpage that is registered by the manager terminal 200. Also, the second data providing unit 130 may be a server or a database that generates and provides the second page data that is the content about the update of the first page data.

In the embodiment of FIG. 2, for description of the inventive concept, it is assumed that the manager terminal 200 or the first user terminal 300-1 among the first to nth user terminals 300 transmits an initial connection request to the first data providing unit 120. Also, the real-time response unit 100 may receive an initial connection request from all the first to nth user terminals 300. The initial connection request may refer to loading the lecture data webpage by inputting a predetermined URL address by the user desiring to listen to the lecture. The first data providing unit 120 receiving the initial connection request transmits user request information to the real-time response unit 110, and the real-time response unit 110 transmits a connection confirmation signal to the manager terminal 200 or the user terminal 300-1. Also, the first data providing unit 120 requests the update data from the second data providing unit 130, and receives the second page data, which is the update content, from the second data providing unit 130.

In the embodiment of FIG. 2, the second page data is data about the updating of the first page data until the time when the initial connection request is received. For example, when the first page data is updated based on an action record request according to an action request, to be described later, the second page data corresponding to the update data until the time when the initial connection request is received may be provided to the user terminal 300, so that the user may receive the content changed until the time when a connection request is transmitted.

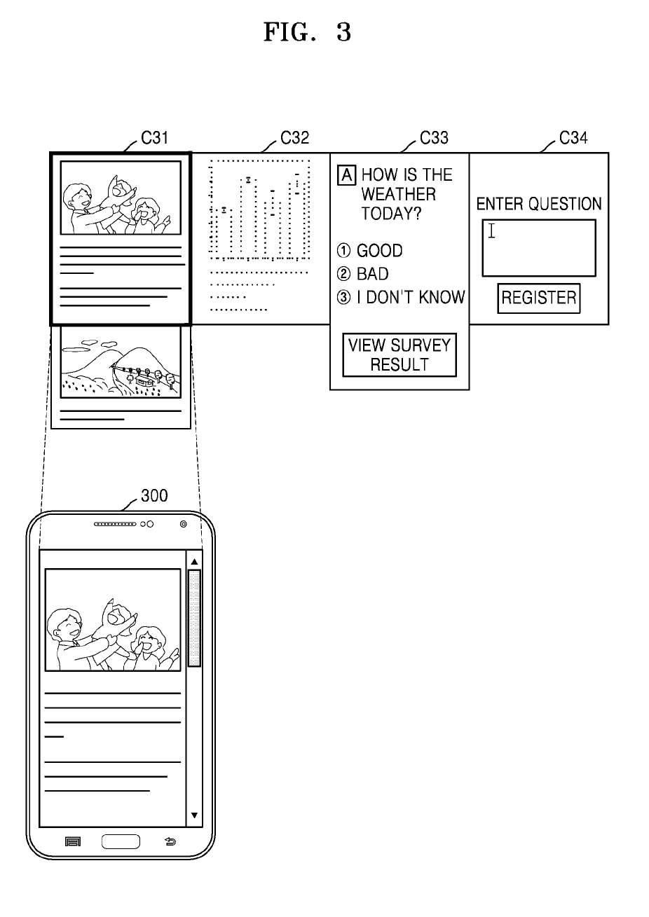

FIG. 3 illustrates an example of the first page data according to an embodiment.

According to an embodiment, the first page data may be webpage content including cut units. FIG. 3 illustrates a case where the first page data is content including four cut units. The respective cuts may be displayed one by one on the user terminal 300, and a switch between the cuts may be performed by a drag-and-drop signal. According to an embodiment, in the entire webpage content, the position of a page displayed on the user terminal 300, for example, a particular displayed cut may be changed by the action request of the manager terminal 200. Also, in the case of a vertically-long cut such as a first cut C31 or a third cut C33, the entire content may be displayed by scrolling in the user terminal 300.

Also, as in the case of a second cut C32, the manager terminal 200 may include non-display content (indicated by dotted lines in FIG. 3) in the first page data. In this case, the non-display content may not be displayed on the user terminal 300 or may be displayed on the user terminal 300 according to the action from the manager terminal 200. This will be described later. As described above, according to an embodiment, the first page data and the second page data are provided to the user terminal 300 transmitting the initial connection request, the first page data is the first content registered by the manager terminal 200, and the second page data is the change data about the first page data, that is, the data for updating the first page data.

In more detail, in the example of the first page data illustrated in FIG. 3, a question page “C34” may be additionally registered. In this manner, the update of the first page data may be generated as the second page data. Also, the second page data may include the update from the first page data until the time when the first user terminal 300-1 transmits the initial connection request. Thus, the page data updated until the time when the initial connection request is transmitted may be displayed on a display unit of the user terminal 300. That is, when the second page data is to add “C34” to the first page data, the added “C34” may also be transmitted to the user terminal 300.

According to an embodiment, when there is an action request from the manager terminal 200 or the user terminal 300, the real-time response unit 110 may determine a type of the action request. The action request may include a first type action request and a second type action request. The first type action request is to request first action response data about the setting change of the page data, and the second type action request is to request second action response data about additional data for updating the page data. In this case, since the real-time response unit 110 is a real-time response server performing a broadcasting function, it transmits only the first and second action response data to the manager terminal 200 or to one or more user terminals 300 and does not provide additional data necessary for response. Alternatively, the manager terminal 200 or one or more user terminals 300 receiving the second action response data may request additional response data from the first data providing unit 120. That is, according to an embodiment, the first action response data for changing the settings of the page data is provided with respect to the first type action request, and the second action response data for requesting additional response data from the second data providing unit 130 is provided with respect to the second type action request. In this case, the page data may be updated by the additional response data.

In more detail, according to an embodiment, the first type action request refers to an action request for requesting the first action response data about the setting change of the page data pre-provided to the manager terminal 200 or the user terminal 300, and a response thereto does not require the manager terminal 200 or the user terminal 300 to communicate with another server or database. For example, the first type action request from the manager terminal 200 may include a hide function activation/deactivation request, or a request for closing receiving of a response to a survey. Also, for example, the first type action request from the user terminal 300 may include a survey response request to not share a survey content response. The first action response data about the first type action request may include, for example, hide function activation or deactivation data, survey response closing data, and/or survey option shading setting data.

According to an embodiment, the second type action request is to request the second type action response data. In this case, the manager terminal 200 or the user terminal 300 receiving the second type action request requests additional response data from the first data providing unit 120, that is, a server different from the real-time response unit 110. For example, the second type action request may include a survey result release request, a new survey registration request, or a new page registration request from the manager terminal 200. Also, for example, the second type action request from the user terminal 300 may include a question registration request or a survey result request. The second action response data about the second type action request may include, for example, new page data, new survey data, survey result data, and/or question list data.

Thus, according to an embodiment, when the change of the page corresponding to the action request may be performed just by the action response generated by the real-time response unit 110, a response may be made to the action request of the manager terminal 200 or the user terminal 300 just by the first action response data of the real-time response unit 110. Thus, according to an embodiment, since the communication load between the real-time response unit 110 and the second data providing unit 130 in the real-time content providing system 100 may be reduced and the communication load between the manager terminal 200 or the user terminal 300 and the first data providing unit 120 may be reduced, the stability of the entire real-time content providing system 100 may be improved.

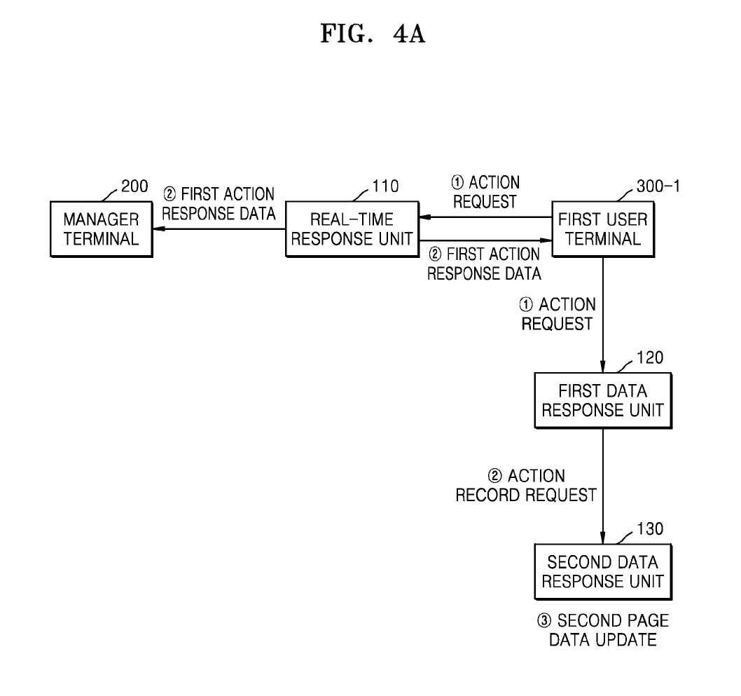

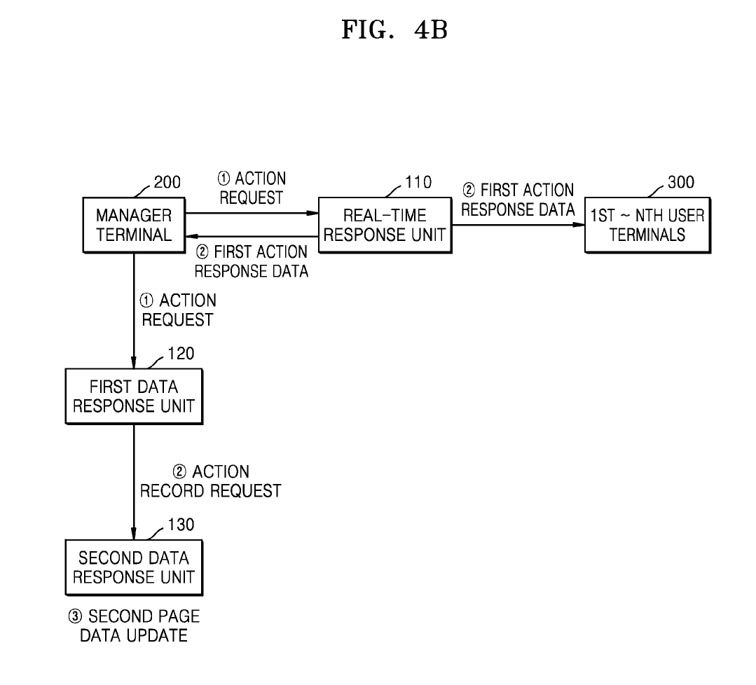

FIGS. 4A and 4B illustrate a case where the first type action request is received, according to an embodiment.

FIG. 4A illustrates a case where the first type action request is received from the first user terminal 300-1, according to an embodiment. When receiving the action request from the first user terminal 300-1, the real-time response unit 110 generates the first action response data corresponding to the received action request and transmits the same to the manager terminal 200 and the user terminal 300. That is, the manager terminal 300 or the user terminal 300 does not need to request or receive data from the first data providing unit 120.

FIG. 4B illustrates a case where the first type action request is received from the manager terminal 200, according to an embodiment. When receiving the action request from the manager terminal 200, the real-time response unit 110 generates the first action response data corresponding to the received action request and transmits the same to one or more of the manager terminal 200 and the user terminal 300. That is, the manager terminal 300 or the user terminal 300 does not need to request or receive data from the first data providing unit 120.

In both cases of FIG. 4A and FIG. 4B, the manager terminal 300 or the user terminal 300 transmits an action request to the first data providing unit 120, and the second data providing unit 130 receives an action record request from the first data providing unit 120 and updates the second page data. As described above, the second page data is data representing the update from the first page data. According to an embodiment, as described above with reference to FIG. 2, since the first page data and the second page data representing the update of the first page data until the present should be provided together according to the request of the user terminal 300, whenever a change occurs in the first page data according to a response request, the second data providing unit 130 may reflect the change to update the second page data.

As described herein, the same-number operations may not necessarily be simultaneously performed regardless of the performance order thereof. For example, although the operations of the manager terminal 200 transmitting action requests to the real-time response unit 110 and the first data providing unit 120 are represented as the same-number operations ( [symbol] ), the two requests may not necessarily be simultaneously transmitted.

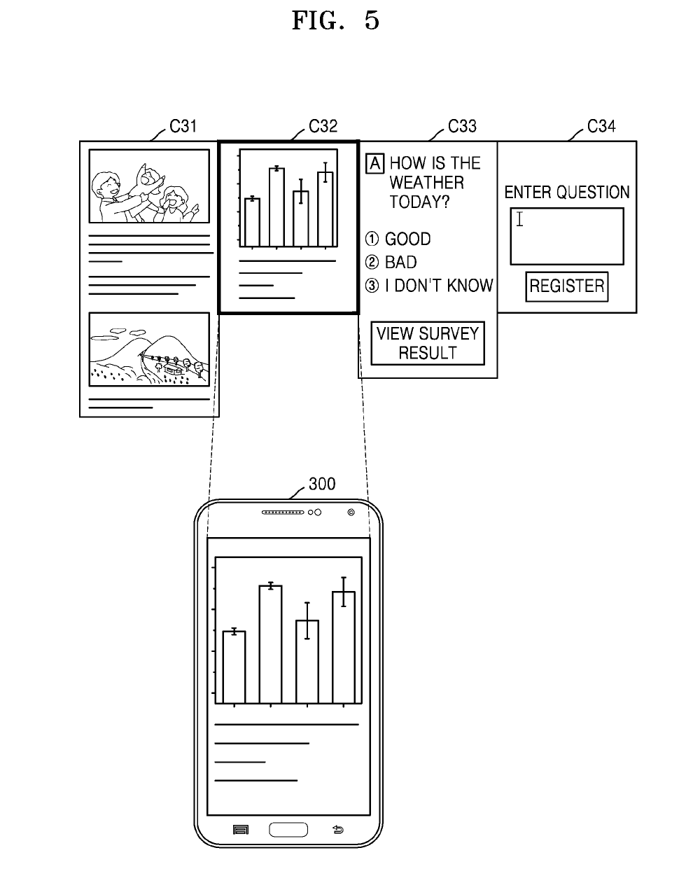

FIG. 5 is a diagram illustrating a method of displaying the content on the user terminal 300 according to an embodiment.

In the embodiment of FIG. 5, following the embodiment of FIG. 3, as the first type action request from the manager terminal 200, the action request may be to unhide the content included in the second page C32. In this manner, since a response may be made to the action request just by the setting change of the pre-provided first page data (and second page data), a response may be made to the action request just by the first action response data generated by the real-time response unit 110 without additional data provided by the second data providing unit 130. FIG. 5 illustrates an example in which the content displayed on the user terminal 300 is changed by the first action response data according to an embodiment. Also, based on the content change illustrated in FIG. 5, the second data providing unit 130 updates the updated second page data.

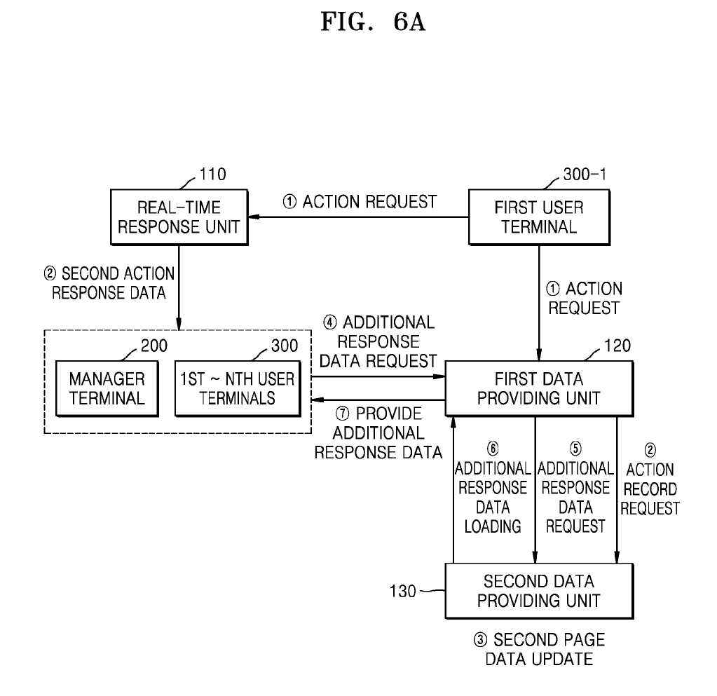

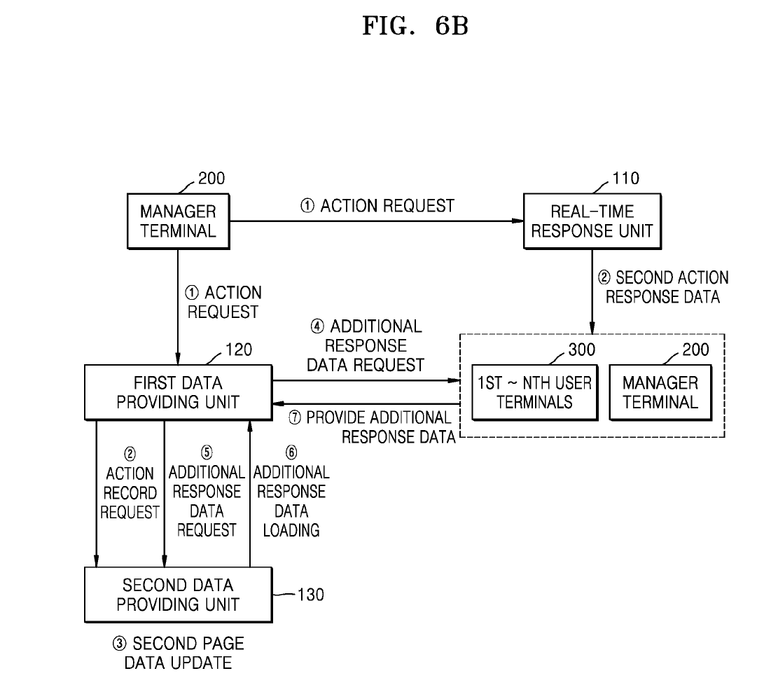

FIGS. 6A and 6B illustrate a case where the second type action request is received according to an embodiment.

FIG. 6A illustrates a case where the second type action request is received from the first user terminal 300-1 according to an embodiment. When receiving the action request from the first user terminal 300-1, the real-time response unit 110 transmits second action response data to the manager terminal 200 and the user terminal 300. The second action response data may include a command for ordering the first data providing unit 120 to request additional response data. This is because it is impossible to make a response to the second type action request just by the setting change of the page data pre-provided to the user terminal 300 and a response thereto should be made by updating the page data by using additional data. Thus, the manager terminal 200 or the user terminal 300 requests additional response data from the first data providing unit 120 and receives additional response data loaded from the second data providing unit 130. Also, the second data providing unit 130 updates the second page data in response to the action request.

FIG. 6B illustrates a case where the second type action request is received from the manager terminal 200 according to an embodiment. When receiving the action request from the manager terminal 200, the real-time response unit 110 transmits second action response data to the manager terminal 200 or the user terminal 300. The second action response data may include a command for ordering the first data providing unit 120 to request additional response data. The manager terminal 200 or the user terminal 300 requests additional response data from the first data providing unit 120 and receives additional response data loaded from the second data providing unit 130. Also, the second data providing unit 130 updates the second page data in response to the action response request.

In comparison with the embodiment of FIGS. 4A and 4B, the embodiment of FIGS. 6A and 6B may additionally include a configuration for the manager terminal 200 or the user terminal 300 to request and receive additional response data from the first data providing unit 120 and a configuration for the first data providing unit 120 to request and load additional response data from the second data providing unit 130 (see 6 to 7 of FIGS. 6A and 6B). In this regard, if it is assumed that the real-time response unit 110 is a broadcasting server, the first data providing unit 120 is a web server, and the second data providing unit 130 is a database, since the broadcasting server does not directly communicate with the database with respect to the first type action request and the terminals do not request data from the web server, the traffic may be reduced and the system stability may be improved. That is, according to the inventive concept, the action requests are classified according to types, and the terminals generate action response data for requesting additional response data only when additional data is required.

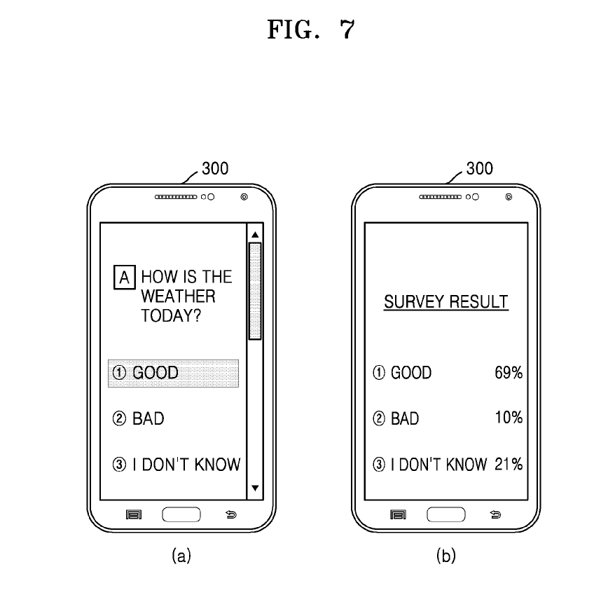

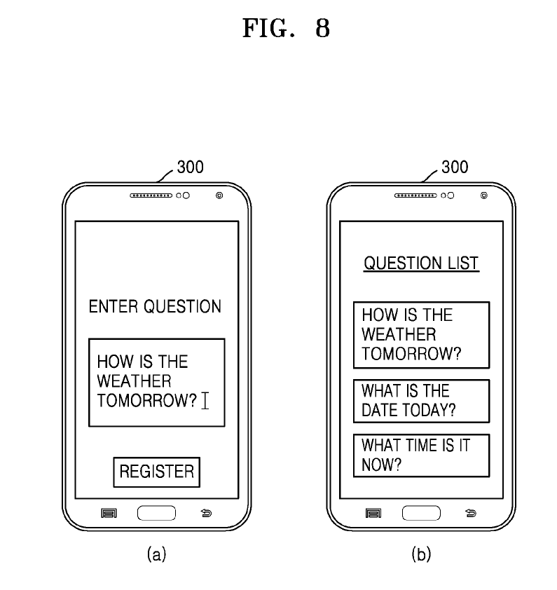

FIGS. 7 and 8 illustrate an example of the content displayed on the user terminal 300 according to an embodiment.

Following the embodiment of FIG. 5, the embodiment of FIG. 7(a) illustrates a case where when the third cut C33 is set as the display content of the user terminal 300, the user transmits the first type action request by selecting the first option “Good”. Since shading an option just by selecting the option as illustrated in FIG. 7 may be performed according to the settings of the pre-loaded page, it does not require the additional response data from the first data providing unit 120. However, as for a first type action request for selecting an objective response of the third cut C33 of FIG. 5, as a result of responding through the first action response data, the option may be shaded as illustrated in FIG. 7(a).

The embodiment of FIG. 7(b) illustrates a survey result page that may be displayed when a survey result request for selecting a “View Survey Result” button of the third cut C33 of FIG. 5 is received as the second type action request from the manager terminal 200. As illustrated in FIG. 7(b), the survey result page is based on the additional response data provided by the second data providing unit 130. The first data providing unit 120 may receive the action request for the survey response from the user terminals 300, so that the second data providing unit 130 may update the second page data.

Following the embodiment of FIG. 5, the embodiment of FIG. 8(a) illustrates a case where the fourth cut C34 is displayed on the user terminal 300 and the user enters a question. When the user presses a “Register” button after entering the question, the second data providing unit 130 may generate the second page data by generating additional data for adding the question list content in response to the action request from the user terminal 300. Also, when there is an action request for requesting the question list data, the user terminal 300 receiving the second action response data requests additional response data about the question list from the first data providing unit 110 and receives the additional response data. As the received additional response data, the question list representing also the questions of other users may be displayed as illustrated in FIG. 8(b).

Particular implementations described herein are merely embodiments, and do not limit the scope of the inventive concept in any way. For the sake of conciseness, descriptions of related art electronic configurations, control systems, software, and other functional aspects of the systems may be omitted. Also, the connection lines or connection members between various elements illustrated in the drawings represent examples of functional connections and/or physical or logical connections between the various elements, and various alternative or additional functional connections, physical connections, or logical connections may be present in practical apparatuses. Also, no element may be essential to the practice of the inventive concept unless the element is specifically described as “essential” or “critical”.

The use of the terms “a”, “an”, and “the” and similar referents in the context of the specification (especially in the context of the following claims) may be construed to cover both the singular and the plural. Also, recitation of a range of values herein are merely intended to serve as a shorthand method of referring individually to each separate value falling within the range, unless otherwise indicated herein, and each separate value is incorporated into the specification as if it was individually recited herein. Also, the operations of the method described herein may be performed in any suitable order unless otherwise indicated herein or otherwise clearly contradicted by the context. The scope of the inventive concept is not limited to the above-described operation order. All examples or exemplary terms (e.g., “such as”) provided herein are merely used to describe the inventive concept in detail, and the scope of the inventive concept is not limited by the examples or exemplary terms unless otherwise claimed. Also, those of ordinary skill in the art will readily understand that various modifications and combinations may be made according to design conditions and factors without departing from the spirit and scope of the inventive concept as defined by the following claims.

The above embodiments of the inventive concept may be embodied in the form of program commands executable through various computer components, which may be recorded on a computer-readable recording medium. The computer-readable recording medium may include program commands, data files, and data structures either alone or in combination. The program commands recorded on the computer-readable recording medium may be those that are especially designed and configured for the inventive concept, or may be those that are known and available to computer programmers skilled in the art. Examples of the computer-readable recording mediums may include magnetic recording mediums such as hard disks, floppy disks, and magnetic tapes, optical recording mediums such as CD-ROMs and DVDs, magneto-optical recording mediums such as floptical disks, and hardware devices such as ROMs, RAMs and flash memories that are especially configured to store and execute program commands. Examples of the program commands may include machine language codes that may be generated by a compiler, and high-level language codes that may be executed by a computer by using an interpreter. The hardware device may be modified into one or more software modules to perform a process according to the inventive concept, and vice versa.

According to the inventive concept, the traffic overload of the real-time content providing system may be prevented.

Also, according to the inventive concept, the lecturer may control in real time the lecture content displayed on the user terminals and the users may share the question result and the survey about the lecture content in real time.

Although the inventive concept has been described above in relation to the drawings, certain embodiments, and particular features such as specific component, this is merely provided to promote a more comprehensive understanding of the inventive concept, the inventive concept is not limited to the above embodiments, and those of ordinary skill in the art may made various modifications therein.

Thus, the spirit of the inventive concept is not limited to the above embodiments, and the scope of the inventive concept may include both the following claims and the equivalents thereof.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the inventive concept as defined by the following claims.

What is claimed is:

1. A real-time content providing method comprising:
providing page data to a plurality of user terminals;
receiving an action request from a manager terminal or from one or more user terminals;
determining a type of the action request; and
transmitting action response data to the manager terminal or the one or more user terminals based on the determined type of the action request,
wherein the action response data is one of first action response data about a setting change of the page data and second action response data about additional data for updating the page data, and the second action response data is used to request additional response data from a server different from a server determining the type of the action request.

2. The real-time content providing method of claim 1, further comprising updating the page data based on an action record request according to the action request.

3. The real-time content providing method of claim 1, wherein the first action response data and the second action response data are transmitted by a first server to the manager terminal or to the one or more user terminals, and the second action response data is used to request additional response data from a second server determining the type of the action request.

4. The real-time content providing method of claim 3, wherein the first server receives the action request from the one or more user terminals in real time and transmits the action response data to the manager terminal or the one or more user terminals in real time.

5. The real-time content providing method of claim 1, wherein the providing of the page data comprises:
receiving an initial connection request from one or more user terminals; and
transmitting the first page data and second page data to the one or more user terminals, wherein
the second page data is data about updating of the first page data until the time when the initial connection request is received; and
the one or more user terminals receiving the first page data and the second page data output the first page data reflecting the second page data by an output unit.

6. The real-time content providing method of claim 1, wherein the determining of the type of the action request comprises determining whether the action request is a first type action request or a second type action request, wherein the first type action request is to request the first action response data and the second type action request is to request the second action response data.

7. The real-time content providing method of claim 1, wherein the first action response data is one of hide function activation or deactivation data, survey response closing data, and survey option shading setting data.

8. The real-time content providing method of claim 1, wherein the second action response data is one of new page data, new survey data, survey result data, and question list data.

9. The real-time content providing method of claim 1, further comprising, before the providing of the page data, a slide providing operation of converting data of a particular format into a slide format to generate the page data.

10. A real-time content providing system comprising:
a real-time response unit configured to receive an action request from a manager terminal or one or more user terminals, determine a type of the action request, and transmit first action response data or second action response data to the manager terminal or the one or more user terminals based on the determined type of the action request;
a first data providing unit configured to receive the action request from the manager terminal or the one or more user terminals; and
a second data providing unit configured to receive an action record request from the first data providing unit and updating page data,
wherein the first action response data relates to the setting change of the page data, and the second action response data relates to additional data for updating the page data and is used to set the manager terminal or the one or more user terminals to request additional response data from the first data providing unit.

11. The real-time content providing system of claim 10, wherein the first data providing unit receiving the additional response data request from the manager terminal or the one or more user terminals is further configured to load the additional response data from the second data providing unit.

12. The real-time content providing system of claim 10, wherein the manager terminal or the one or more user terminals receiving the first action response data are further configured to change the settings of the page data without requesting the additional response data from the first data providing unit.

13. The real-time content providing system of claim 10, further comprising a slide providing unit configured to convert data of a particular format into a slide format to generate the page data.
